(19) United States
(12) Patent Application Publication
(10) Pub. No.: US 2017/0097121 A1
(43) Pub. Date: Apr. 6, 2017

(54) COMPRESSED GAS STORAGE SYSTEM

(71) Applicant: JOHNSON RESEARCH & DEVELOPMENT CO., INC., Atlanta, GA (US)

(72) Inventor: Lonnie G. Johnson, Atlanta, GA (US)

(21) Appl. No.: 15/287,468

(22) Filed: Oct. 6, 2016

Related U.S. Application Data
(60) Provisional application No. 62/237,703, filed on Oct. 6, 2015.

(51) Int. Cl. F17C 13/02; F17C 1/00; F17C 11/00; F04B 49/02

(52) U.S. Cl. CPC F17C 13/025; F04B 49/022; F17C 1/00; F17C 11/007; F17C 2203/0604; F17C 2250/03; F17C 2250/0626; F17C 2221/033; F17C 2205/0332

(57) ABSTRACT

A pressurized gas storage system is disclosed for maintaining a minimum pressure of a primary fluid (5). The system includes a pressurized gas tank (2) inside which is mounted a flexible bladder (4) which contains the primary fluid. The space between the gas tank and the bladder is considered a compression chamber (9) which contains a secondary fluid (7) that exerts pressure on the bladder to maintain a minimum pressure upon the primary fluid. The secondary fluid is supplied to and exits tank pressure chamber through a port (6). The flexible bladder is couple to inlet outlet port (8) extending to a pickup tube (10). The system also includes a pump (18), fluid reservoir (14), pressure relief valve (24) and controller (26) which functions to maintain the pressure of the secondary fluid. In a second embodiment, pressure is maintained through a second fluid absorbing and releasing material.

### REFERENCE TO RELATED APPLICATION

Applicant claims the benefit of U.S. Provisional Patent Application Ser. No. 62/237,703 filed Oct. 6, 2015.

### TECHNICAL FIELD

This invention relates generally to a system for storing and distributing compressed gas.

### BACKGROUND OF INVENTION

Often a substantial portion of pressurized gas stored in tanks cannot be used because of the need to supply gas from the tank at some minimum pressure. Typically there is an inherent drop in pressure as gas is extracted from the storage tank. The inherent drop in pressure limits the ability to use the storage tanks to top-off other pressurized storage tanks.

Natural gas is typically stored in tanks at pressures in the range of 4,000 psi for distribution and consumption. Tanks have been designed to contain even higher pressures as a means for maximizing the amount of gas which can be put into a given tank. However, the use of higher pressure cannot be justified when considering the additional weight, cost of the tank and the expense associated with pressurizing the gas to higher pressure. In addition, depending on the type of gas, higher pressure may only provide an insignificant increase in the amount of gas in the tank because of the super supercompressibility factor “z” correction to the ideal gas law for that gas.

At standard or atmospheric conditions, the gas z factor is always approximately 1, which means that the gas behaves as an ideal gas. At high pressures, the z factor increases above 1, where the gas is no longer super-compressible. At these conditions, the specific volume of the gas is becoming so small, and the distance between molecules is much smaller, such that the density is more strongly affected by the volume occupied by the individual molecules. Hence, the z factor continues to increase above unity as the pressure increases. Under these conditions, the addition of a relatively small amount of gas to a tank can cause a dramatic increase in pressure.

FIG. 1, shows the z correction factor for natural gas. The z correction factor represents the deviation from the ideal gas law for a real pressurized gas where

$$pV = znRt$$

$$z = \frac{Actual volume of gas at specified T and p}{Ideal volume of gas at same T and p}$$

The amount of gas stored becomes:

$$nR = \frac{pV}{zT}$$

The plot is for natural gas at a temperature of 90° F. The significant change in z factor with pressure limits the effectiveness of using higher pressure to store greater amounts of gas. For example, the z factor for natural gas at 2,000 psi is 0.704. This means that for a given volume and temperature the amount of gas stored is 1.42 (1/0.704) times higher than that of an ideal gas at that temperature. This means that the amount of hydrogen stored is equivalent to an ideal gas at 2,841 psi. On the other hand, the z factor at 4,000 psi is 0.84 giving an equivalent storage of 4,761 psi, nearly 5,000 psi. At 6,000 psi, the z factor is 1. However at 10,000 psi the z factor is about 1.5 which gives an equivalent storage of only about 6,600 psi. Thus, the diminishing returns realized by trying to use higher pressure to store increased amounts of natural gas is often not justified by the additional cost associated with the higher pressure tanks and associated equipment.

The problem of being limited by a maximum practical pressure at which a gas is stored is compounded by the inherent drop in pressure that occurs as gas is consumed from the tank. Often, there is a minimum residual tank pressure below which gas cannot be effectively utilized. For example, the application may be gas stored for subsequent supply to some other tank such as for a natural gas powered vehicles. If a vehicle to be refueled already contains hydrogen stored at 2,000 psi and needs to take on additional fuel to a level of 4,000 psi, then a resupply tank that contains gas at a pressure of only 3,000 psi will be of limited utility as a direct supply source.

If the full amount of gas can be supplied from a tank at or near the tanks maximum pressure, then the net result will be equivalent, from a usage perspective, to being able to store a greater amount of gas in the tank. A greater amount of gas will enter and leave the tank during a given charge discharge cycle.

Accordingly, it is seen that a need remains for a method and apparatus for storing and distributing compressed gas in an effective manner. It is to the provision of such therefore that the present invention is primarily directed.

### BRIEF DESCRIPTION OF DRAWINGS

FIG. 1 is a graph illustrating the pressure vs “z” factor for natural gas.

FIG. 2 is a schematic view of a compressed gas storage system in a preferred form of the invention.

FIG. 3 is a schematic view of a compressed gas storage system in another preferred form of the invention.

FIG. 4 is a graph illustrating the desorption isotherms for Zr_{0.8}Sc_{0.2}Fe₂—H₂ system (Intermetallic Hydrides With High Dissociation Pressure.

FIG. 5 is a graph illustrating the volumetric density of hydrogen as a function of pressure at ambient temperature.

FIG. 6 is a schematic view of a compressed gas storage system in still another preferred form of the invention.

### DETAILED DESCRIPTION

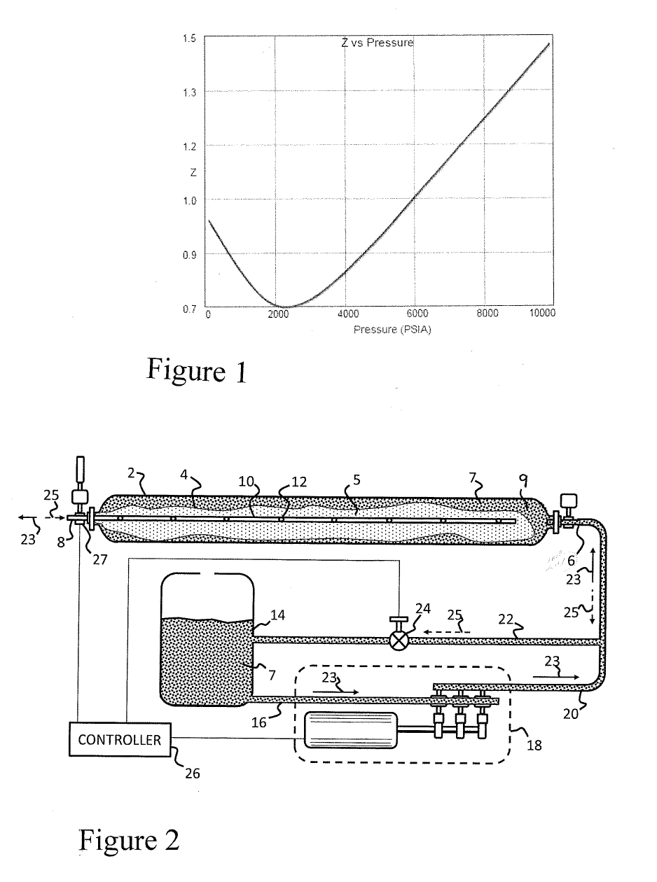

A pressurized gas storage system is hereby disclosed for maintaining a minimum pressure of gas stored in a tank in a preferred form of the invention. Referring to a first preferred embodiment of the invention shown in FIG. 2, the system's pressurized gas tank 2 is fitted with an inlet/outlet port 8 and an inlet outlet port 6. A primary fluid 5, such as a gas or liquid, is stored within a flexible bladder 4 which is positioned within an elongated, pressurized gas tank 2. The tank 2 contains a secondary fluid 7 between the bladder 4 and pressurized gas tank 2 for exerting pressure on the bladder to maintain the stored primary fluid inside the bladder at a minimum desired pressure. The space between the bladder 4 and pressurized gas tank 2 may be referred to herein as the compression chamber 9.

The secondary fluid 7 is supplied to and exits tank pressure chamber 9 through an inlet outlet port 6. The flexible bladder 4 is positioned inside of gas tank 2 and couple to an inlet outlet port 8 so that it may expand and contract within the confines of the tank. The primary fluid 5 is contained within bladder 4 wherein it enters and exits the bladder through port 8. A gas pickup tube 10 extends the interior length of the bladder 4 such that gas entering and exiting bladder 4 passes through tube 10. The tube 10 has access openings, pores or ports 12 extending along its longitudinal length such that in the event of a collapse of bladder 4 near inlet/outlet port 8, which may occur when the bladder is being emptied, flow of the primary fluid from other regions within the bladder to inlet/outlet port 8 will be maintained. The region inside tank 2 that is exterior to bladder 4, referred to herein as the pressure chamber 9, is filled with the pressurized secondary fluid 7.

The system also includes a pump 18, fluid reservoir 14, pressure relief valve 24 and controller 26 function to maintain the pressure of the secondary fluid 7 within a narrow preselected range of pressures and thereby the pressure inside of gas tank 2. Motorized pressure pump 18 extracts the secondary fluid 7 from reservoir 14 via conduit 16, pressurizes the secondary fluid 7, and supplies it to inlet/outlet port 6 via conduit 20 as indicated by flow arrows 23. On the other hand, pressure relief valve 24 allows pressurized secondary fluid to return from tank 2 to reservoir 14 via conduit 22, as indicated by arrow 25.

Operation of the system is such that a preselected maximum and minimum pressure of the stored primary fluid is maintained as the primary fluid is compressed into or extracted from gas tank 2. When primary fluid 5 is supplied to the bladder 4 within the gas tank 2, pressurized secondary fluid 7 within the pressure chamber 9 of the gas tank is allowed to flow back through valve 24 whenever the maximum preset pressure within the pressure chamber 9 is reached. This action is controlled by controller 26 which is electrically coupled to and in control of the inlet/outlet 8, pump 18, and the relief valve 24. Pressure relief valve 24 is basically an overpressure valve that opens to allow the return flow of secondary fluid 7 back to reservoir 14. Pressure relief valve 24 prevents over pressurization of gas tank 2 and allows the flow of secondary fluid 7 to reservoir 14 to make room for the inflowing of primary fluid 5 into the bladder inside gas tank 2. The pressure relief valve 24 does not open when the tank pressure is below its preset pressure level. On the other hand, pressurization pump 18 operates to pressurize secondary fluid 7 from reservoir 14 and supply it to the pressure chamber 9 of the gas tank 2 as the primary fluid 5 is removed from gas tank 2 when the pressure drops below a preset minimum sensed by controller 26. The controller 26 actuates pump 18 to operate to maintain a minimum pressure within tank 2 as primary fluid 5 is withdrawn from the bladder 4. By operating in this manner, primary fluid 5 is maintained at a sufficiently high pressure to function at a consistently effective pressurized fluid resupply source. Secondary fluid 7 is preferably a liquid so as to more easily enable more efficient pressurization and pumping.

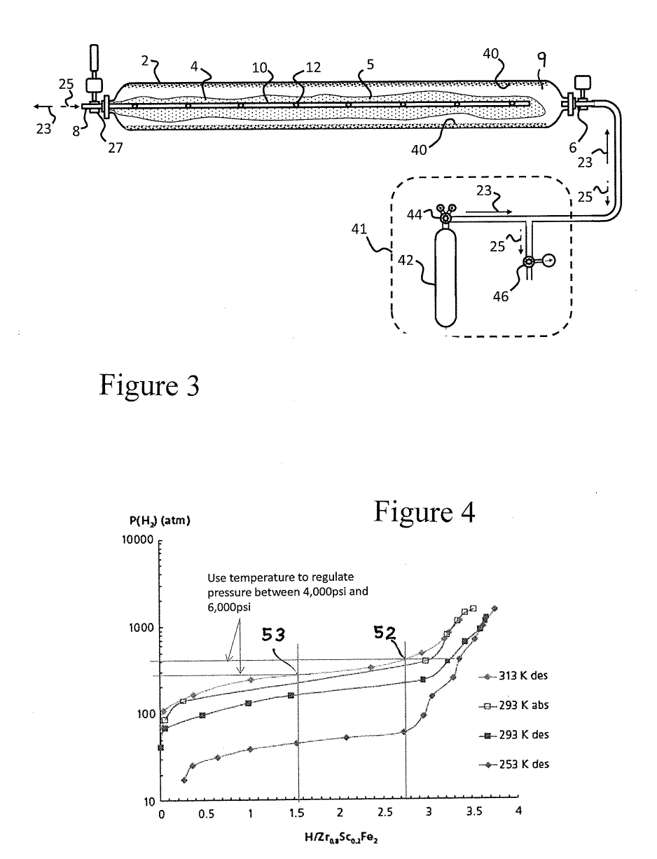

FIG. 3 shows a second embodiment of the invention in a preferred form for maintaining a narrow operating pressure range for pressurized fluid stored inside a gas tank. Similar to the configuration shown in FIG. 2, primary fluid 5 is stored inside a bladder 4 positioned within the gas tank 2. Here, hydrogen gas is utilized as the secondary fluid. A mass of metal hydride material 40 within the pressure chamber 9 is used to store hydrogen gas within the targeted operating pressure range of the primary gas 5. Metal hydride 40 is configured within a liner that is attached to the inside surface of gas tank 2 such that it is in thermal equilibrium with the wall of the tank and thereby more closely coupled to the ambient temperature of the tank's environment.

A given volume of metal hydride may be selected for this application depending on the desired maximum and minimum pressures and the range of ambient temperatures to be experienced at the location where the compressed gas storage system is to be operated. FIG. 4 shows the hydrogen pressure versus atomic molar ratio of hydrogen for Zr_{0.8}Sc_{0.2}Fe₂ as an example metal hydride. This particular metal hydride is included only as an example and is not intended to represent any particular or practical application, i.e., it is not intended to represent a limitation of the invention to a particular form. It should be noted that the plateaus have a slope such that the metal hydride may be operated in a region of high hydrogen content during low temperature seasons and in a region of low hydrogen content during high temperature seasons, which results in a pressure range over which the metal hydride absorbs and releases hydrogen in a pressure range which remains relatively consistent.

From FIG. 4, for Zr_{0.8}Sc_{0.2}Fe₂—H₂ at 313° K (40° C.) and 2.75 hydrogen atoms/mole of metal hydride, the hydrogen pressure would be approximately 400 bar (6,000 psi), state or level 52 (see FIG. 4 reference 52). The average density of Zr_{0.8}Sc_{0.2}Fe₂ is 6832 kg/m³. The molar mass of Zr_{0.8}Sc_{0.2}Fe₂ is 0.5(91.2)+0.5(45)+2(55.8)=179.7 g/mole. Based on the metal hydride's density, the molar density is 38,019 moles of metal hydride/m³. Referring to FIG. 4 at hydrogen content level 52, the atomic molar ratio of 2.75 atoms of hydrogen per molecule of metal hydride, the molar density of hydrogen within the metal hydride would be 104,552 moles H₂/m³ (38,019 moles MH molecules/m³*2.75H₂ atoms/molecule). At atomic mass of 1 g/mole, the density of hydrogen in the metal hydride at 6,000 psi is 104 kg_{H2}/m³_{MH}.

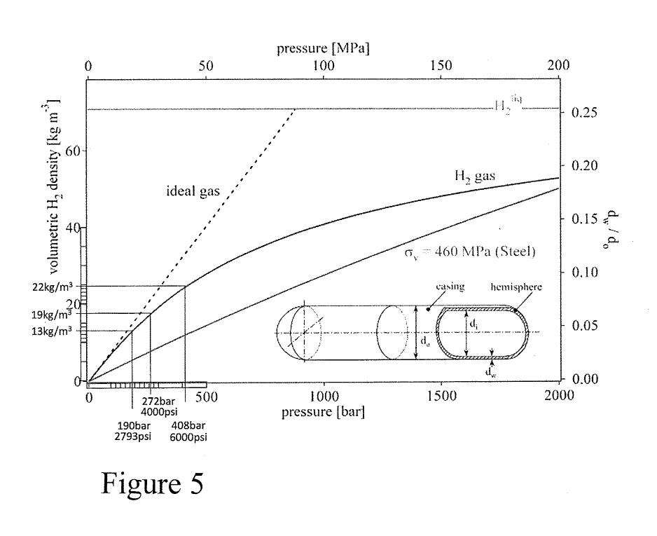

The volume of a typical natural gas tank is about 2.3 m³. Assume a minimum desired pressure of 4,000 psi after primary fluid 5 has been removed. From FIG. 5, the mass of hydrogen in a storage tank at 4,000 psi can be approximated as 19 kg/m³. A 2.3 m³ tank emptied of primary fluid 5 would contain 43.7 kg of hydrogen at 4,000 psi. At 6,000 psi, the metal hydride contains 104 kg_{H2}/m_{MH}³. From FIG. 4, at 4,000 psi, state or level 53 (see FIG. 4 reference 53), the hydrogen content would be an atomic molar ratio of 1.55, a reduction of 43.4% from the atomic molar ratio of 2.73 at 6,000 psi. Given that 43.7 kg of hydrogen must represent 43.4% of the hydrogen available in the total amount of metal hydride in order to operate between 4,000 psi and 6,000 psi, the amount of metal hydride material required is approximately 0.97 m³_{MH}, (=43.7 kg/(43.4%*104 kg_{H2}/m³_{MH})). The density of the Zr_{0.8}Sc_{0.2}Fe₂ metal hydride is approximately 6832 kg/m³ which results in approximately 6,614 kg of metal hydride being needed to maintain the minimum pressure.

From FIG. 4, at the assumed operating temperature of 40° C. (313° K), the hydrogen will be released by the metal hydride above the minimum 270 bar (4,000 psi). The particular metal hydride material selected for this application will be determined by the targeted range of operating ambient temperature and the targeted primary fluid operating pressure range. In this example, the additional volume of the metal hydride would require a tank volume of 3.3 m³ as opposed to the standard tank volume of 2.3 m³. However, it is anticipated that selection of an optimum metal hydride will require only 0.5 m³ as opposed to 1 m³ as described in this example Referring to FIG. 3, the metal hydride based pressure control system includes pressure regulator 41. Regulator 41 includes pressurized hydrogen gas source 42 within a control valve 44 and a pressure relief valve 46. The hydrogen pressure from the metal hydride depends on its hydrogen content and temperature. During periods of low temperature, additional hydrogen is supplied from gas source 42 to insure that the minimum pressure within tank 2 remains above the targeted operating point. On the other hand, under conditions of increased ambient temperature, pressure relief valve 46 is used to release hydrogen and thereby insure that the maximum tank operating pressure is not exceeded. By operating in this manner, the system can compensate for the impact that seasonal variations in ambient temperature will have on the operating pressure range of the system.

Thus, it should be understood that the gas storage system includes a persistent pressure source to maintain the pressure within the pressure chamber 9 located within the gas tank 2. In the first embodiment of FIG. 2, the persistent pressure source is comprised of a mechanical pressure pump to induce pressure, while in the second embodiment of FIG. 3 the persistent pressure source is comprised of a mass of gas absorbing and releasing material (mass of metal hydride material) which absorbs and releases gas while maintaining the gas within a narrow pressure range.

It should also be understood that the relative positioning of the first and second fluid may be reversed, i.e., the secondary fluid 7 is positioned within the bladder while the primary fluid 5 is located between the bladder and the gas tank. In the reversed configuration, the secondary fluid inflates the bladder 4 to increase the pressure within the pressure chamber 9 containing the primary fluid, thereby maintaining the primary fluid at a constant high pressure. Obviously, the valves and associated equipment must be similarly changed.

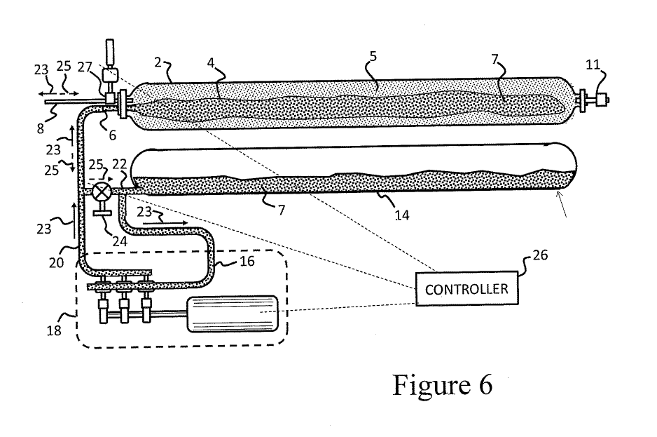

With reference next to the embodiment shown in FIG. 6, a pressurized gas storage system is hereby disclosed for maintaining a minimum pressure of gas stored in a tank. A primary fluid 5, such as a gas or liquid, is stored within a tank 2 and externally of a flexible bladder 4 which is positioned within a pressurized tank 2, i.e., stored between the bladder 4 and the tank 2. The bladder 4 contains a secondary fluid 7 for exerting pressure on the primary fluid as the bladder expands, to maintain the stored primary fluid at a minimum desired pressure.

The system's pressurized gas tank 2 is fitted with a primary fluid inlet/outlet port 8 and a secondary fluid inlet/outlet port 6. The secondary fluid 7 is supplied to and exits bladder 4 through port 6 so that it may expand and contract within the confines of the tank. The primary fluid 5 is contained within the chamber or area between the bladder and the pressure tank 2 wherein it enters and exits through port 8 and the gas pickup tube 10 coupled thereto. The region inside tank 2 that is exterior to bladder 4, referred in this embodiment as the pressure chamber 9, is filled with the primary fluid 5. The tank 2 also includes a pressure release valve 11 which prevents the accidental over pressurization of the tank.

The system also includes a pump 18, fluid reservoir 14, pressure relief valve 24 and controller 26 which function to maintain the pressure of the secondary fluid 7 within a narrow preselected range of pressures and thereby the pressure inside of tank 2. Motorized pressure pump 18 extracts the secondary fluid 7 from reservoir 14 via conduit 16, pressurizes the secondary fluid 7, and supplies it to inlet/outlet port 6 via conduit 20 as indicated by flow arrows 23 and thereafter the bladder 4. The pressure relief valve 24 allows pressurized secondary fluid to return from bladder 4 to reservoir 14 via conduit 22, as indicated by arrow 25.

Operation of the system is such that a preselected maximum and minimum pressure of the stored primary fluid is maintained as the primary fluid is compressed into or extracted from tank 2. When primary fluid 5 is supplied to the tank/pressure chamber 9, pressurized secondary fluid 7 within the bladder 4 is allowed to flow back through valve 24 whenever the maximum preset pressure within the pressure chamber 9 is reached. Pressure relief valve 24 is basically an overpressure valve that opens to allow the return flow of secondary fluid 7 back to reservoir 14. Pressure relief valve 24 prevents over pressurization of bladder and allows the flow of fluid 7 to reservoir 14 to make room for the inflowing of primary fluid 5 into the pressure chamber 9 inside tank 2. It does not open when the tank pressure is below its preset pressure level. On the other hand, pressurization pump 18 operates to pressurize secondary fluid 7 from reservoir 14 and supply it to bladder 4 as the primary fluid 5 is removed from tank 2 and the pressure drops below a preset minimum. Pump 18 operates to maintain a minimum pressure within tank 2 (pressure chamber 9) as primary fluid 5 is withdrawn. By operating in this manner, primary fluid 5 is maintained at a sufficiently high pressure to function at a consistently effective pressurized fluid resupply source. Secondary fluid 7 is preferably a liquid so as to more easily enable more efficient pressurization and pumping.

It should be understood that the reconfiguration of the bladder which changes pressure within either the pressure chamber 9 or the expandable bladder 4 should be considered to be a force. In FIGS. 2 and 3 the increase in pressure within the pressure chamber 9 creates a contracting force upon the bladder 4. In FIG. 6 the increase in pressure within the bladder 4 creates an expanding force upon the bladder resulting a force being applied to the fluid within the pressure chamber 9.

It thus is seen that a compressed gas storage system is now provided which overcomes problems associated with prior art systems. While this invention has been described in detail with particular references to the preferred embodiments thereof, it should be understood that many modifications, additions and deletions, in addition to those expressly recited, may be made thereto without departure from the spirit and scope of the invention.

1. A pressurized gas storage system comprising:
a pressure tank;
an expandable bladder, the expandable bladder being mounted within said pressure tank and holding a secondary fluid;
said expandable bladder creating a pressure chamber between said bladder and said pressure tank for holding a primary fluid; and
a persistent pressure source, said persistent pressure source being coupled to the bladder and supplying and removing the secondary fluid therefrom while maintaining a prescribed pressure range thereof;
whereby the supply and removal of the secondary fluid under persistent pressure to and from the expandable bladder causes the expandable bladder to expand and contract as primary fluid is removed from and supplied to the pressure chamber.

2. The pressurized gas storage system of claim 1 wherein said persistent pressure source comprises a pump;
a fluid conduit coupling said pump to said bladder; and
a reservoir in fluid communication with said fluid conduit, said reservoir containing a quantity of the second fluid;
whereby the pump supplies the second fluid to the bladder when the pressure within the bladder drops below a predetermined level.

3. The pressurized gas storage system of claim 2 further comprising a pressure relief valve in fluid communication with said expandable bladder and said reservoir and operating to couple fluid flow from said bladder to said reservoir when the pressure within said expandable bladder within the pressure chamber exceeds a predetermined level.

4. A pressurized gas storage system comprising:
a pressure tank;
an expandable bladder for holding a primary fluid to be distributed under pressure, said expandable bladder being mounted within said pressure tank and spaced from said pressure tank to create a pressure chamber between said bladder and said pressure tank to hold a secondary fluid;
a fluid pump in fluid communication with said pressure chamber to increase the pressure of the second fluid within said pressure chamber;
a first fluid conduit in fluid communication with the interior of said expandable bladder; and
a fluid reservoir in fluid communication with said pressure chamber, said reservoir containing a quantity of the second fluid,
whereby the second fluid may exert pressure upon the expandable bladder to increase the pressure of a first fluid contained within the expandable bladder.

5. The pressurized gas storage system of claim 4 further comprising a second conduit extending between said fluid reservoir and said pressure chamber, and a relief valve coupled to said second conduit to allow the passage of the second fluid between said pressure chamber and said fluid reservoir to reduce the pressure within the pressure chamber.

6. The pressurized gas storage system of claim 4 further comprising a controller electrically coupled to said fluid pump to control the actuation of said fluid pump.

7. The pressurized gas storage system of claim 4 wherein said pressure tank is elongated along a longitudinal direction, and wherein said first fluid conduit includes an elongated hollow tube extending along the longitudinal direction of said pressure tank, said hollow tube having a series of openings along its longitudinal length.

8. A pressurized gas storage system comprising:
a pressure tank;
an expandable bladder for holding a primary fluid to be distributed under pressure, said expandable bladder being mounted within said pressure tank and spaced from said pressure tank to create a pressure chamber between said bladder and said pressure tank to hold a secondary fluid;
a quantity of second fluid absorbing material in fluid communication with said pressure chamber to absorb or release the second fluid to vary the of the second fluid within said pressure chamber;
a first fluid conduit in fluid communication with the interior of said expandable bladder; and
a fluid reservoir in fluid communication with said pressure chamber, said reservoir containing a quantity of the second fluid,
whereby the second fluid may exert pressure upon the expandable bladder to increase the pressure of a first fluid contained within the expandable bladder.

9. The pressurized gas storage system of claim 8 wherein said second fluid absorbing material is a metal hydride material.

10. The pressurized gas storage system of claim 8 further comprising a second conduit extending between said fluid reservoir and said pressure chamber, and a relief valve coupled to said second conduit to allow the passage of the second fluid from said pressure chamber to reduce the pressure within the pressure chamber.

11. The pressurized gas storage system of claim 8 wherein said pressure tank is elongated along a longitudinal direction, and wherein said first fluid conduit includes an elongated hollow tube extending along the longitudinal direction of said pressure tank, said hollow tube having a series of openings along its longitudinal length.

12. A pressurized gas storage system comprising:
a pressure tank;
an expandable bladder for holding a first fluid, the expandable bladder being mounted within and spaced from said pressure tank to form a chamber for holding a second fluid;
a persistent pressure source in fluid communication with either said expandable bladder or said chamber, said persistent pressure source providing a difference in pressure to reconfigure said expandable bladder to change the pressure of one said fluid which results in a force being applied to said expandable bladder to change the pressure of the other said fluid.

13. The pressurized gas storage system of claim 12 wherein the first fluid is a fluid to be distributed under pressure.

14. The pressurized gas storage system of claim 12 wherein the second fluid is a fluid to be distributed under pressure.

15. The pressurized gas storage system of claim 12 wherein said persistent pressure source comprises a pump;
a fluid conduit coupling said pump to said bladder; and
a reservoir in fluid communication with said fluid conduit, said reservoir containing a quantity of the second fluid;
whereby the pump supplies the second fluid to the bladder when the pressure within the bladder drops below a predetermined level.

16. The pressurized gas storage system of claim 12 further comprising a pressure relief valve in fluid communication with said expandable bladder and said reservoir and operating to couple fluid flow from said bladder to said reservoir when the pressure within said expandable bladder within the pressure chamber exceeds a predetermined level.
